(19) United States
(12) Patent Application Publication
(10) Pub. No.: US 2017/0105397 A1
(43) Pub. Date: Apr. 20, 2017

(54) Catch Monitoring Device

(71) Applicant: Smart Catch LLC, Palo Alto, CA (US)

(72) Inventors: Robert Mark Terry, Palo Alto, CA (US); Scott Andrew Steber, San Francisco, CA (US); Gregory Lewis Kress, Redwood City, CA (US); Agustus Berman Shelander, San Mateo, CA (US)

(21) Appl. No.: 14/886,316

(22) Filed: Oct. 19, 2015

(51) Int. Cl. A01K 73/02; H04L 29/06; H04N 7/18; H04L 29/08; A01K 75/02

(52) U.S. Cl. CPC A01K 73/02; H04L 67/12; A01K 75/02; H04N 7/185; H04L 65/607; H04L 65/4069

(57) ABSTRACT

Disclosed is a device configured to enable monitoring of the subsea surroundings of a trawl net or other seafood gathering device. The device comprises a cylindrical shell. The cylindrical shell comprises a sensor that generates data pertaining to the subsea surroundings of the device. The cylindrical shell also comprises a light source. The light source is a light-emitting device or a reflected beam of light. The sensor and the light source are rotatable around an axis extending to the ends of the cylindrical shell. The device further comprises one or more electrical components coupled to the sensor and the light source, and additionally communicatively coupled to a data processing device. At least a part of the cylindrical shell is transparent.

### CLAIM OF PRIORITY

This application is a non-provisional application claiming priority to U.S. Provisional Patent Application Ser. No. 62/146,221, filed Apr. 10, 2015, the entire disclosure of which is hereby expressly incorporated by reference herein.

### FIELD OF TECHNOLOGY

This disclosure relates generally to data processing devices and, more particularly, to a device and/or systems of monitoring seafood gathering devices.

### BACKGROUND

Fishing nets are non-discriminatory and provide no means by which fishers can monitor their catch and the surroundings of their trawl net in real-time. As a result, one out of four fish caught are the wrong fish, and are usually returned to the sea, dead or dying. Accumulation of this waste over thousands of years has led to a worldwide crisis of overfishing that is threatening a total collapse of our planet's wild fish stocks.

Overfishing occurs when an off-season fish is caught and fishers are forced to throw away the fish in order to limit their loss. Such waste also occurs when fishers exceed their quotas and are obligated by government regulations to throw away the excess. Beyond mere overfishing, fishers often catch nothing after hours of casting their nets. In this way, countless hours and gallons of fuel are spent to no avail. Wasting fuel also causes excess pollution and contributes to acidification of the oceans.

Current seafood gathering monitoring devices are prohibitively expensive, are difficult or even impossible to integrate into current equipment, or provide no utility to a fishermen. As such, fishers are driven away from these solutions due to their high cost and low to utility. Without a cheap, reliable means of monitoring their nets, pots, or other seafood gathering equipment, fishers have no choice but to continue blindly casting their nets and hoping not only to catch the right fish, but any fish at all.

### SUMMARY

Disclosed are a device and/or systems of monitoring seafood gathering devices.

In one aspect, a seafood catch monitoring device configured to enable monitoring of the subsea surroundings of said device comprises a cylindrical shell. The cylindrical shell comprises a sensor generating data pertaining to the subsea surroundings of the seafood catch monitoring device. The cylindrical shell also comprises a light source. The light source is one of a light-emitting device and a reflected beam of light. The sensor and the light source are rotatable around an axis extending to the ends of the cylindrical shell. The cylindrical shell also comprises one or more electrical components coupled to the sensor and the light source, and additionally communicatively coupled to a data processing device. At least a part of the cylindrical shell is transparent.

In another aspect, a seafood catch monitoring system comprises a data processing device. The seafood catch monitoring system also comprises a seafood catch monitoring device configured to enable monitoring of the subsea surroundings of the seafood catch monitoring device. The seafood catch monitoring device comprises a sensor generating data pertaining to the subsea surroundings of the seafood catch monitoring device. The seafood catch monitoring device also comprises a light source. The light source is one of a light-emitting device and a reflected beam of light. The sensor and the light source are rotatable around an axis extending to the ends of the cylindrical shell. The seafood catch monitoring device also comprises one or more electrical components coupled to the sensor and the light source. The one or more electrical components are also communicatively coupled to the data processing device. At least a part of the seafood catch monitoring device is transparent.

In yet another aspect, a seafood catch monitoring system comprises a seafood catch monitoring device. The seafood catch monitoring device comprises a sensor, a light source, and a processor coupled to the sensor and the light. The seafood catch monitoring device also comprises a memory storing instructions. When the instructions are executed by the processor, they cause the seafood catch monitoring device to operate the sensor and the light source to enable monitoring of the subsea surroundings of the seafood catch monitoring system. The instructions also cause the seafood catch monitoring device to generate raw media through the sensor and communicate the raw media to an encoder coupled to the processor. Furthermore, the instructions cause the seafood catch monitoring device to encode, through the encoder, the raw media. The seafood catch monitoring system also comprises a data processing device. The data processing device comprises a decoder, a display unit, and a processor. The processor is communicatively coupled to the processor of the seafood catch monitoring device through a network. The processor is configured to receive encoded media from the seafood catch monitoring device through the network. The data processing device also comprises a memory storing instructions. When the instructions are executed by the processor, the instructions cause the data processing device to decode the encoded media through the decoder and display, through the processor, the decoded media on the display unit.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a perspective view of a seafood catch monitoring device, according to one or more embodiments.

FIG. 2 is a perspective view of the seafood catch monitoring device of FIG. 1 integrated into a net, according to one or more embodiments.

FIG. 3 is a schematic of the seafood catch monitoring device of FIG. 1 communicatively coupled to a data processing device on a fishing vessel, according to one or more embodiments.

FIG. 4 is a side view of the seafood catch monitoring device of FIG. 1, according to one or more embodiments.

FIG. 5A is a side view showing component detail of a cylindrical shell of the seafood catch monitoring device of FIG. 1, according to one or more embodiments.

FIG. 5B is a side view showing component detail of a mounting bracket of the cylindrical shell of FIG. 5A, according to one or more embodiments.

FIG. 6A is an embodiment of the seafood catch monitoring device of FIG. 1 coupled to other seafood catch monitoring devices, according to one or more embodiments.

FIG. 6B is another embodiment of the seafood catch monitoring device of FIG. 1 coupled to other seafood catch monitoring devices, according to one or more embodiments.

FIG. 7 is a block diagram of the component enclosure of the seafood catch monitoring device of FIG. 1, according to one or more embodiments.

Other features of the present embodiments will be apparent from the accompanying drawings and from the detailed description that follows.

### DETAILED DESCRIPTION

Example embodiments, as described below, may be used to provide examples of a device and/or systems of monitoring seafood gathering devices.

Fishers require a monitoring unit that can be easily integrated into their current equipment (e.g. nets, fishing pots, onboard computers, etc.) and that can be easily manipulated to allow a fisher to monitor wide angles. Such a monitoring unit is ideally modular and can be scaled to meet the monitoring needs of any scale operation. Furthermore, the unit is ideally network-enabled and can be accessed by data processing devices through an intranet shared by the monitoring unit. In a large-scale operation, the monitoring unit is ideally accessible remotely through a wide-area network using an Internet protocol (IP).

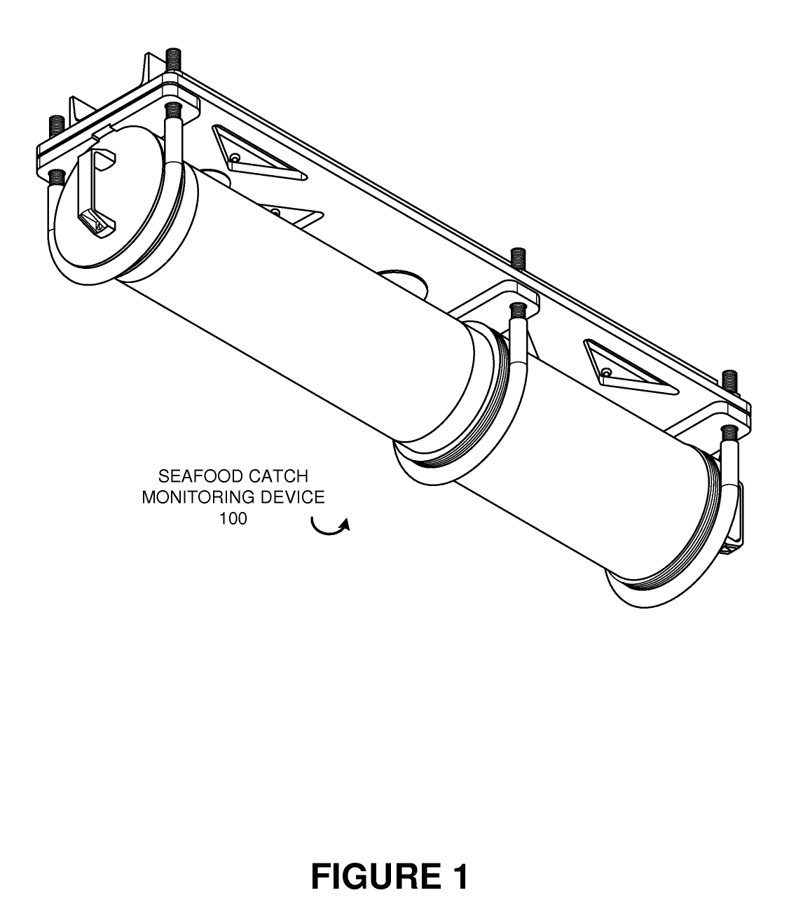

Reference is now made to FIG. 1, which is a perspective view of a seafood catch monitoring device 100, according to one or more embodiments. The seafood catch monitoring device 100 is a monitoring unit designed to be integrated into a seafood harvesting device (e.g. a net, a fishing pot, a seine net, etc.) in order to monitor the contents therein.

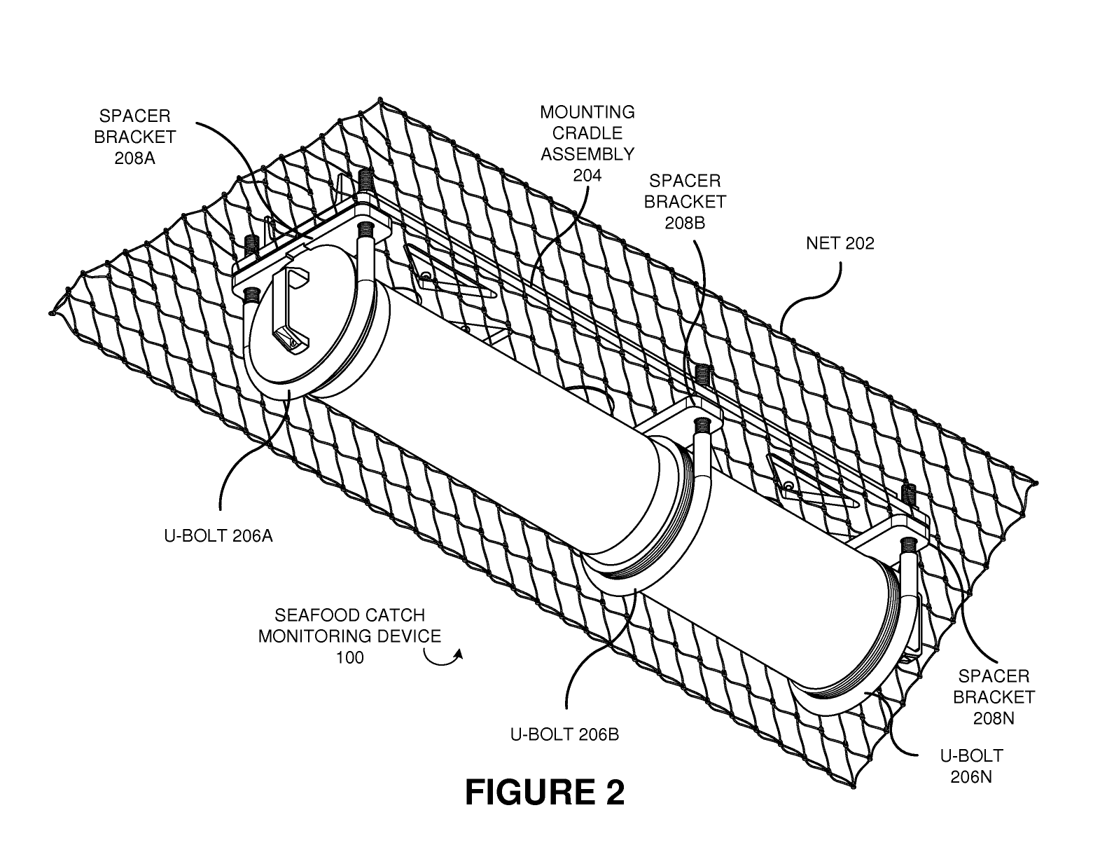

Reference is now made to FIG. 2, which is a perspective view of the seafood catch monitoring device 100 of FIG. 1 integrated into a net 202, according to one or more embodiments. The net 202 may be part of a trawl net, a seine net, or may be a fishing pot. The seafood catch monitoring device 100 may be fastened to a mounting cradle assembly 204 with the net 202 disposed between the seafood catch monitoring device 100 and the mounting cradle assembly 204.

The seafood catch monitoring device 100 may be fastened to the mounting cradle assembly 204 by one or more U-bolts 206A-N. Between the seafood catch monitoring device 100 and the mounting cradle assembly 204 may be disposed one or more spacer brackets 208A-N. The spacer brackets 208A-N may prevent slippage of the net 202 and/or may prevent agitation of the seafood catch monitoring device 100. The net 202 may be positioned between the spacer brackets 208A-N and the seafood catch monitoring device 100 or the net 202 may be positioned between the mounting cradle assembly 204 and the spacer brackets 208A-N. Alternately, the spacer brackets 208A-N may not be used and the net 202 may be positioned between the seafood catch monitoring device 100 and the mounting cradle assembly 204.

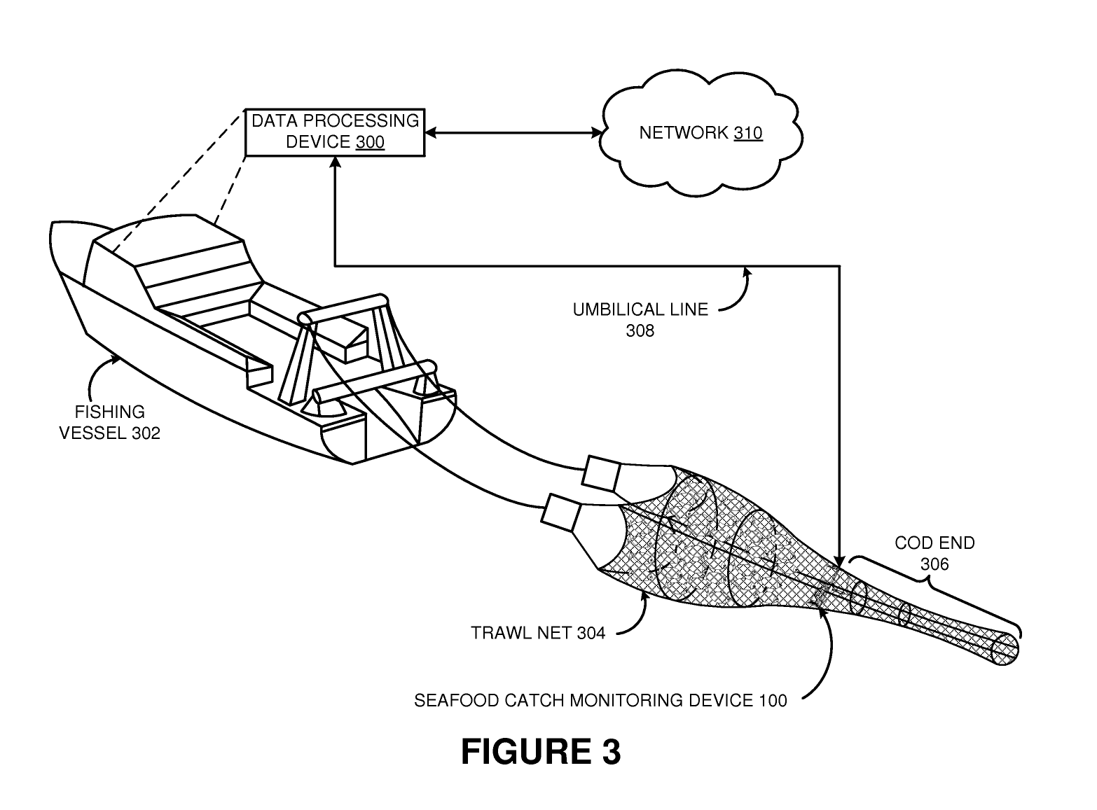

Reference is now made to FIG. 3, which shows a schematic of the seafood catch monitoring device 100 of FIG. 1 communicatively coupled to a data processing device 300 on a fishing vessel 302, according to one or more embodiments. The seafood catch monitoring device 100 may be positioned before the cod end 306 of a trawl net 304 being towed by the fishing vessel 302. The purpose of positioning the seafood catch monitoring device 100 between the head rope and the cod end 306 of the trawl net 304 may be to enable monitoring of fish flowing into the cod end 306. When viewing a video stream generated by the seafood catch monitoring device 100, a fishing vessel operator in the fishing vessel 302 may be able to notice if non-target fish are heading into the cod end 306. Before the non-target fish reach the cod end 306, the operator may take measures to avoid catching the non-target fish, such as adapting the speed and/or trajectory of the fishing vessel 302 to prevent catching the non-target fish (i.e. so that the fish may successfully swim out and away from the trawl net 304). The fishing vessel operator may alternately activate a pre-catch release mechanism of the trawl net 304 if available. The pre-catch release mechanism may be communicatively coupled to the seafood catch monitoring device 100 and may receive command signals through the seafood catch monitoring device 100 or from the data processing device 300.

The seafood catch monitoring device 100 may relay data through an umbilical line 308 (or umbilical cable) to a data processing device 300 onboard the fishing vessel 302 to enable remote monitoring of the contents of the seafood harvesting device. The umbilical line 308 may transmit an encoded video signal (e.g. using VDSL technology) through an IP protocol to be decoded by the data processing device 300 to enable real-time monitoring of the contents of the trawl net 304 through the seafood catch monitoring device 100. Alternately, the video signal may be compressed by the data processing device 300 and stored in a memory of the data processing device 300.

In one embodiment, the data processing device 300 may be communicatively coupled to a network 310. The seafood catch monitoring device 100 may also be communicatively coupled to the network 310 either directly or through the data processing device 300. The network 310 may be a personal area network (PAN) or a wide-area network (WAN) and may enable connectivity between the devices of the fishing vessel 302 (e.g. the seafood catch monitoring device 100, the data processing device 300, etc.) and other data processing endpoints. The data processing endpoints may be off-shore or on-shore and may be associated with any number of stakeholders. For example, a fishing vessel owner may be on-shore and may desire to view the contents of the trawl net 304 of the fishing vessel 302 to determine if fish are being caught, and if so, what types of fish are being caught. The fishing vessel owner may remotely view a real-time video feed of the trawl net 304 through a network-enabled data processing device (e.g. a personal computer, a smartphone, etc.). Alternately, a government oversight agency may desire to conduct a random inspection of a fishing operation and may target fishing vessel 302. Through a network-enabled data processing device, the government oversight agency may remotely view the real-time video feed of the trawl net 304 contents to determine the species of fish being caught. Alternately, the government oversight agency may remotely view video feed archives. This may facilitate oversight/inspection and drive down costs for fishermen and oversight agencies.

Regular operation of the seafood catch monitoring device 100 may comprise the utilization of one or more mechanical components of the seafood catch monitoring device 100. The mechanical components of the seafood catch monitoring device 100 may comprise at least one sensor and/or at least one light source. The sensor may be a video camera device, a side scan sonar system, or an infrared camera. Other sensors that enable visual monitoring may be used and are within the scope of the exemplary embodiments described herein.

The configuration of the mechanical components of the seafood catch monitoring device 100 may enable active monitoring of the subsea surroundings of the trawl net 304 by rotating the sensor around an axis extending through one or more cylindrical portions of the seafood catch monitoring device 100. For example, if the sensor is a low-light video camera, rotation of the low-light video camera within the seafood catch monitoring device 100 may enable monitoring of the subsea surroundings of the trawl net 304.

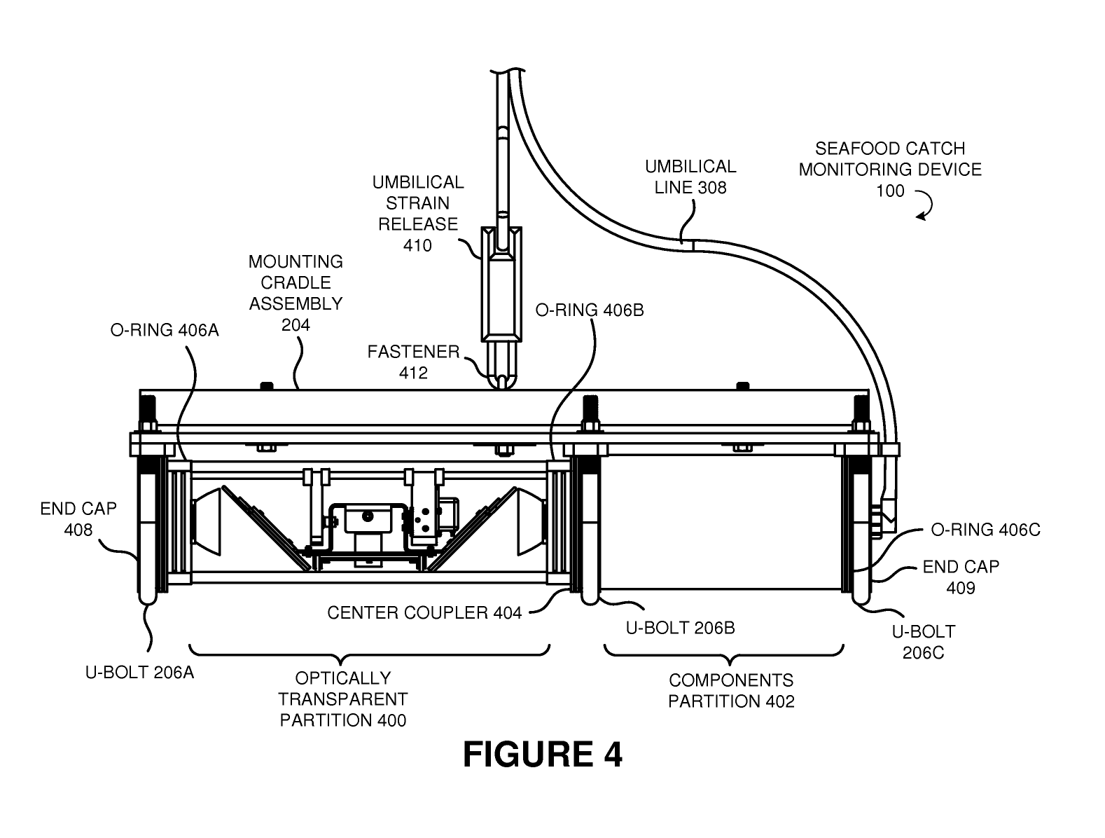

Reference is now made to FIG. 4, which is a side view of the seafood catch monitoring device 100 of FIG. 1, according to one or more embodiments. The seafood catch monitoring device 100 may comprise a cylindrical shell composed of one or more partitions. Any partition of the one or more partitions may be transparent. In one embodiment, the cylindrical shell may be composed of an optically transparent partition 400 and a components partition 402. Alternately, the cylindrical shell may be composed of a single partition. The optically transparent partition 400 may be composed of an optically transparent material, such as acrylic. The use of acrylic may prevent distortion of light entering or leaving the interior of the first cylindrical portion. Other optically transparent and/or distortion-preventing materials may compose the shell of the optically transparent partition 400 and are within the scope of the exemplary embodiments described herein. One end of the optically transparent partition 400 may comprise a center coupler 404 to which the components partition 402 may be coupled. Between the center coupler 404 and each of the optically transparent partition 400 and the components partition 402 may be an O-ring 406B positioned in a manner such that the seafood catch monitoring device 100 is sealed under high pressure environments (e.g. deep sea environments). Other coupling configurations, such as a screw fitting, may be used to couple each of the optically transparent partition 400 and the components partition 402 to the center coupler 404, and may be within the scope of the exemplary embodiments described herein.

Each distal end of the optically transparent partition 400 and the components partition 402 may comprise an end cap 408-9. Between each end cap 408-9 and each distal end of the optically transparent partition 400 and the components partition 402 may be an O-ring (e.g. O-ring 406A, O-ring 406C) positioned in a manner such that the seafood catch monitoring device 100 is sealed under high pressure environments (e.g. deep sea environments). Other coupling configurations, such as a screw fitting, may be used to couple each of the optically transparent partition 400 and the components partition 402 to their respective end cap (e.g. end cap 408 or end cap 409), and may be within the scope of the exemplary embodiments described herein. The end cap 409 at the distal end of the components partition 402 may be configured to provide a coupling means for the umbilical line 308.

The umbilical line 308 may extend away from the end cap 409 of the components partition 402, and, at a pre-determined length, may be coupled to an umbilical strain release 410. The umbilical strain release 410 may be coupled to the mounting cradle assembly 204. The purpose of the umbilical strain release 410 may be to relieve strain and/or tension on the umbilical line 308 due to towing, especially in deep sea environments where the strain on the umbilical line 308 can exceed several thousand pounds. As such, the umbilical strain release 410 may prevent loss of monitoring capability of the seafood catch monitoring device 100 by indirectly coupling the umbilical line 308 to the mounting cradle assembly 204. As such, the umbilical strain release 410 serves as a first point of failure by establishing a more secure connection between the umbilical line 308 and the seafood catch monitoring device 100. The umbilical strain release 410 may be hooked into a fastener 412 positioned around the middle of the mounting cradle assembly 204.

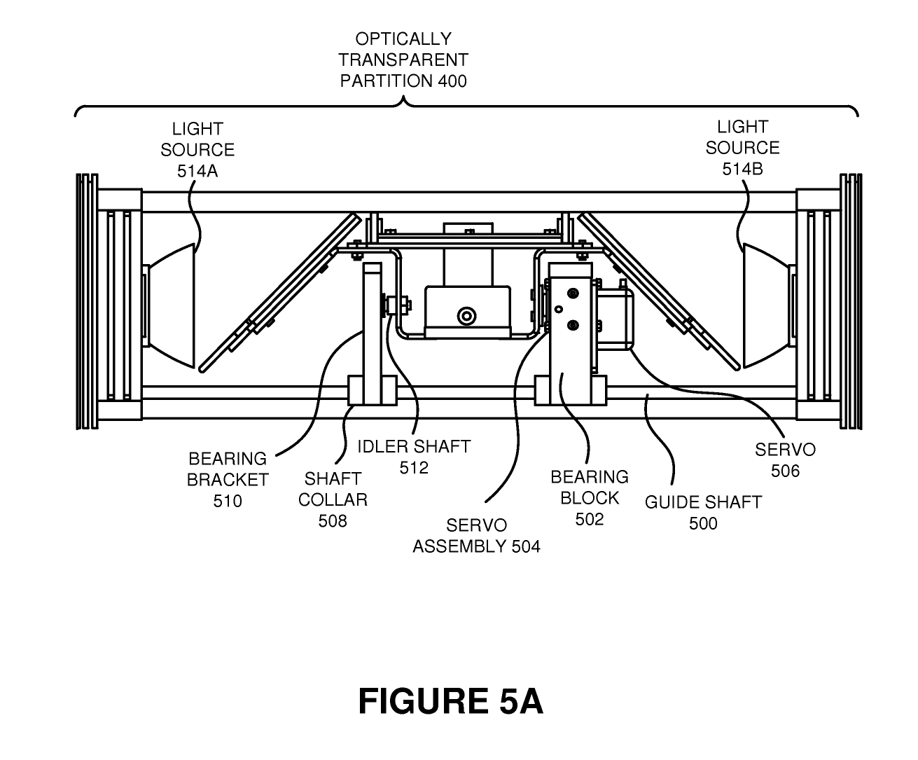

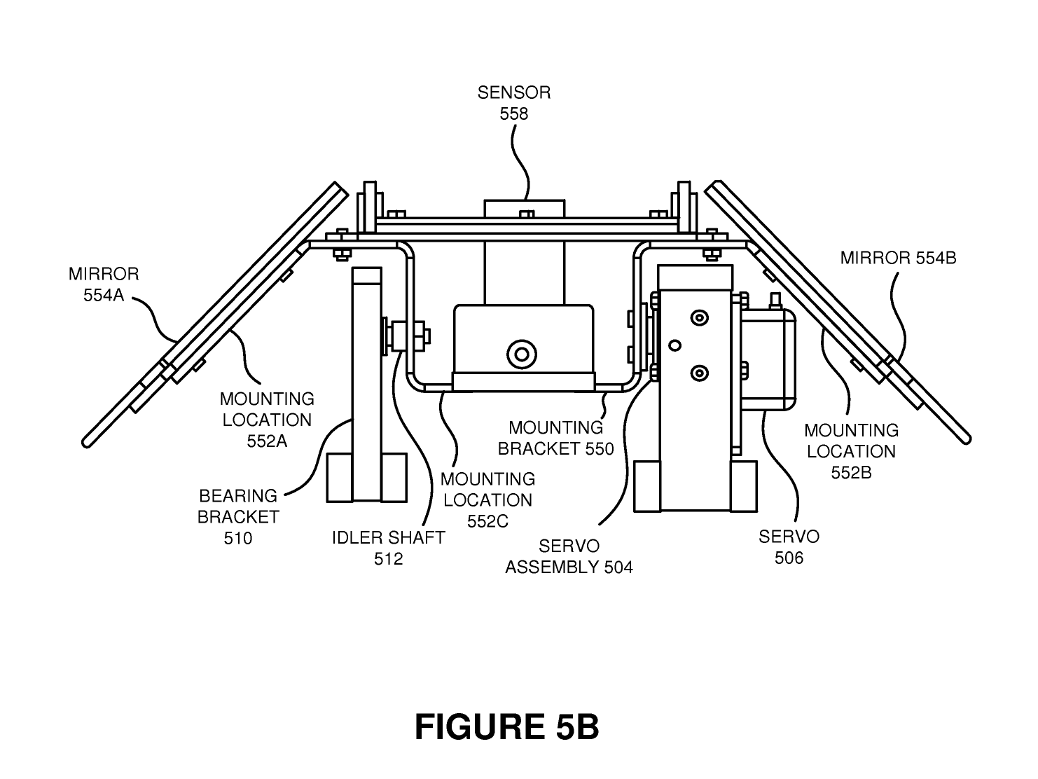

Reference is now made to FIG. 5A, which is a side view showing component detail of the optically transparent partition 400 of the seafood catch monitoring device 100, according to one or more embodiments. The optically transparent partition 400 may comprise a guide shaft 500 extending length-wise within the optically transparent partition 400 and coupled to the ends of the optically transparent partition 400. The guide shaft 500 may extend beyond the ends of the optically transparent partition 400, but at least one or more segments of the guide shaft 500 may be fixed at the ends of the optically transparent partition 400. A bearing block 502 may be coupled orthogonally to the guide shaft 500, the bearing block 502 having a servo assembly 504 to which a servo 506 may be coupled, the servo 506 facing toward one end of the optically transparent partition 400. A shaft collar 508 may be coupled to the guide shaft 500 and may fasten a bearing bracket 510 to the guide shaft 500. The bearing bracket 510 may be orthogonally disposed in relation to the guide shaft 500. The bearing bracket 510 may house one end of an idler shaft 512 orthogonally positioned with respect to the bearing bracket 510.

Reference is now made to FIG. 5B, which is a side view showing component detail of a mounting bracket 550 of the optically transparent partition 400 of FIG. 5A, according to one or more embodiments. The mounting bracket 550 as shown in FIG. 5B is a thin strip of rigid material shaped to form a number of mounting locations 552A-C. In the particular embodiment shown in FIG. 5B, the mounting bracket 550 may be bent in one or more locations to form one or more mounting locations 552A-C. In one embodiment, a mounting location 552A may be a portion of the mounting bracket 550 disposed at an angle such that mounting a mirror 554A on the mounting location 552A may enable reflection of a light source 514A. Similarly, a mounting location 552B may be another portion of the mounting bracket 550 disposed at an angle.

The angle of the mounting location 552B may mirror the angle of the mounting location 552A and may enable reflection of the light source 514B. Angled in this way, the mounting location 552A and the mounting location 552B may allow light reflected by the mirror 554A and the mirror 554B to converge. The angles of the mounting location 552A and the mounting location 552B may be static or dynamic. In the case of dynamic angles, the mounting location 552A may be coupled to a servo, which servo may be coupled to the mounting bracket 550. In an alternate embodiment, the mounting location 552B may be coupled to a servo, which servo may be coupled to the mounting bracket 550. In another embodiment, both the mounting location 552A and the mounting location 552B may be coupled to servos, which servos may be coupled to the mounting bracket 550. Allowing the mounting locations 552A-B to individually change their respective angles may enable beams of light reflected by the mirrors 554A-B to converge in different locations along a plane extending vertically and laterally through the mounting bracket 550. Alternately, in another embodiment, light source(s) may be coupled directly to the mounting locations 552A-B, thus requiring no mirrors to reflect the beams of light from the light source(s).

The mounting bracket 550 may comprise a mounting location 552C. The mounting location 552C may be a segment of the mounting bracket 550 extended between the mounting location 552A and the mounting location 552B. The mounting location 552C may be suitable for mounting a sensor 558. In concert, the mirror 554A, the mirror 554B and the sensor 558 may be used to monitor objects in the immediate surroundings of the mounting bracket 550. The sensor 558 may be a video camera device configured to monitor low-light surroundings. Alternately, the sensor 558 may be a side-scan sonar. Other types and numbers of sensors may be used and are within the scope of the embodiments described herein.

The mounting bracket 550 may rotate around an axis extending through the mounting bracket 550 and the sensor 558 (the axis is not shown). Where the axis meets the mounting bracket 550, the mounting bracket 550 may be coupled to the idler shaft 512 and the servo assembly 504 of FIG. 5A. The idler shaft 512 may be fixed to the mounting bracket 550 and may rotate within a ball bearing of the bearing bracket 510. The axis may extend through the sensor 558 and where it meets the mounting bracket 550 again, the servo assembly 504 may be coupled to the mounting bracket 504. As such, operation of the servo 506 may rotate the mounting bracket 550 around the axis. Rotation of the mounting bracket 550 and by extension, the mounting locations 552A-C may improve the monitoring capabilities of the seafood catch monitoring device 100.

In one embodiment, the seafood catch monitoring device 100 may be positioned along the head rope of a trawl net. Though the seafood catch monitoring device 100 may be positioned anywhere within or without the trawl net, positioning the seafood catch monitoring device 100 along the head rope may allow a user of the seafood catch monitoring device 100 to monitor a flow of fish entering the trawl net through the sensor 558 of the seafood catch monitoring device 100. Rotation of the mounting bracket 550 may permit the user to follow the movement of the fish (e.g. to confirm whether the fish is entering the net) and adjust the field of view (FOV). For example, if particulate matter obscures the FOV of the seafood catch monitoring device 100, a user of the seafood catch monitoring device 100 may rotate the mounting bracket 550 to regain vision of the contents of the seafood catch monitoring device 100.

The physical configuration of the components of the optically transparent partition 400 including, but not limited to the angular dispositions of the mounting locations 552A-B; the extension of the mounting location 552C; the positioning of the light sources 514A-B in relation to the mirrors 554A-B; the positioning, number and type of the sensor 558; the locations on the mounting bracket 550 to which the idler shaft 512 and the servo assembly 504 are coupled; and any other physical aspect of the mounting bracket 550, the servo 506, the servo assembly 504, the bearing bracket 510, the idler shaft 512, the bearing block 502, and the guide shaft 500 may differ from the embodiments illustrated in FIG. 5A-B and described herein. Accordingly, the figures and the specification thereof are to be regarded in an illustrative sense rather than a restrictive sense.

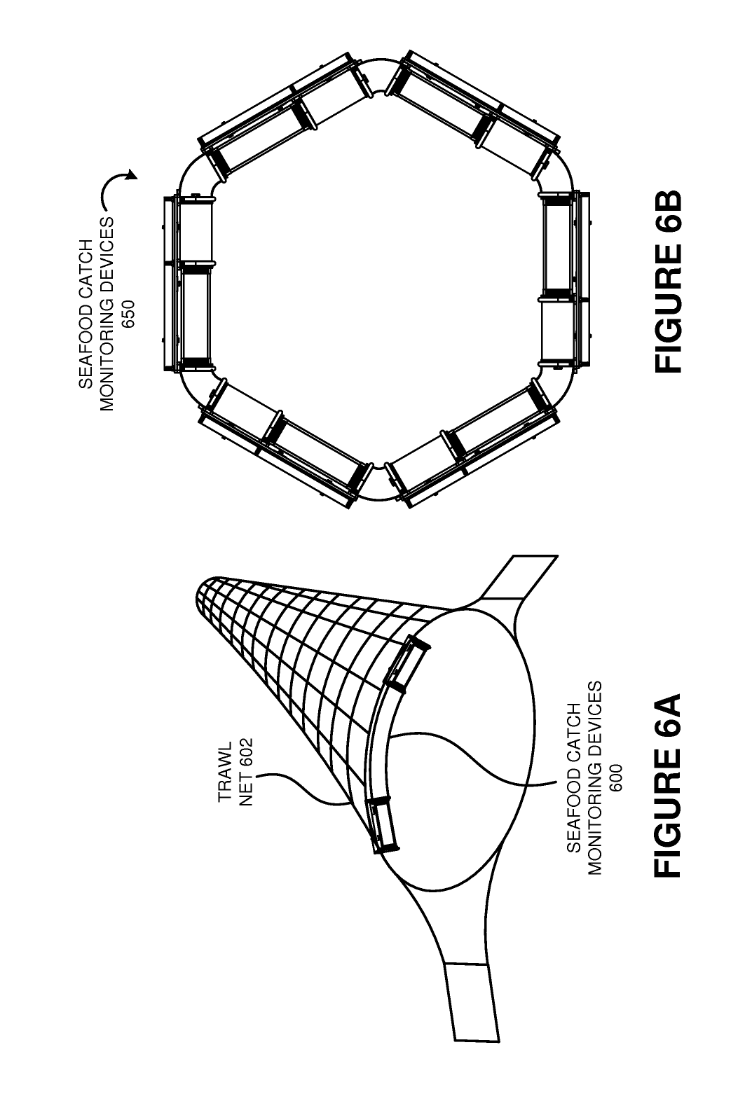

Reference is now made to FIG. 6A, which illustrates an embodiment of the seafood catch monitoring device of FIG. 1 coupled to one or more seafood catch monitoring devices, according to one or more embodiments. The seafood catch monitoring device 100 is modular in that it can be expanded to support multiple partitions, each of which may be configured as a monitoring unit (e.g. the optically transparent partition 400) or a components enclosure (e.g. the components partition 402). In one embodiment, one or more seafood catch monitoring devices 600 may collectively be coupled to a trawl net 602 and positioned therein to enable monitoring of the contents of the trawl net 602 from multiple angles. Any number of seafood catch monitoring devices 600 and any configuration thereof are within the scope of the exemplary embodiments discussed herein.

Reference is now made to FIG. 6B, which illustrates another embodiment of the seafood catch monitoring device 100 of FIG. 1 coupled to one or more seafood catch monitoring devices 650, according to one or more embodiments. One or more seafood catch monitoring devices 650 may be coupled and arranged in any shape to fit the needs of the operation. For example, to facilitate an image recognition process or a biomass measurement, a hexagonal configuration may be shown. Alternately, the image recognition process or biomass measurement may be better facilitated by a swarm of light-weight, networked monitoring units housed within optically transparent partitions positioned throughout the trawl net 602. As such, the embodiment demonstrated in FIG. 6B is to be regarded in an illustrative rather than a restrictive sense. For example, one or more seafood catch monitoring devices may be coupled linearly and placed lengthwise within the trawl net 602. Such a linear configuration may allow monitoring of a fish throughout the length of the net and may provide added visibility within the net.

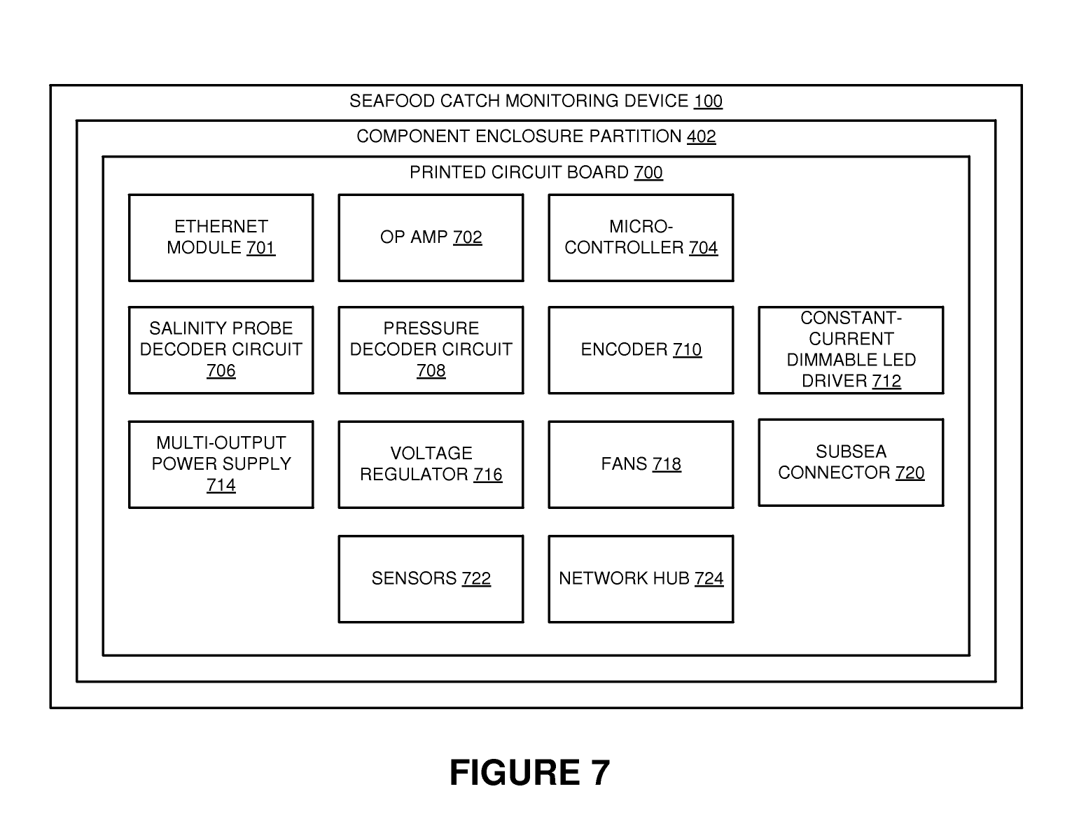

Reference is now made to FIG. 7, which is a block diagram of the component enclosure of the seafood catch monitoring device of FIG. 1, according to one or more embodiments. The component enclosure may comprise one or more electrical components. The one or more electrical components may comprise a printed circuit board (PCB) 700. The PCB 700 may comprise an ethernet module 701, an op amp 702, a micro-controller 704, a salinity probe decoder circuit 706, a pressure transducer 708, an encoder 710, a constant-current dimmable LED driver 712, multi-output power supply 714, a voltage regulator 716, one or more fans 718, a subsea connector 720, one or more sensors 722, and a network hub 724.

The ethernet module 701 may facilitate an ethernet connection between the seafood catch monitoring device 100 and other data processing end points. The op amp 702 may be a lighting and control circuit allowing a state of an electrical signal to the light sources 514A-B to be changed. The micro-controller 704 may be a processor or a system-on-a-chip (SoC). For example, the micro-controller 704 may be a Teensy USB development board. Other micro-controllers may be used and are within the scope of the exemplary embodiments described herein. The salinity probe decoder circuit 706 may comprise a probe coupled to the cylindrical shell that measures the salinity of water surrounding the cylindrical shell based on an electrical signal received by the probe through the cylindrical shell. The pressure transducer 708 may be configured to determine an internal and/or external pressure of the seafood catch monitoring device 100. The encoder 710 may be used to encode an IP video feed. The constant-current dimmable LED driver 712 may be a step-down transformer that feeds an electrical signal to the light sources 514A-B. The constant-current dimmable LED driver 712 may be configured to allow dimming of the light sources 514A-B. The voltage regulator 716 may clean a source of electricity being fed into the seafood catch monitoring device 100. The multi-output power supply 714 may receive a particular amount of voltage from the voltage regulator 716, which the multi-output power supply 714 may split into separate voltages to be fed into separate electrical circuits on the one or more PCBs. For example, the voltage regulator 716 may regulate a 24V line and feed the output to the multi-output power supply 714, which may split the 24V line into a 12V line (e.g. to be output to the constant-current dimmable LED driver 712, and subsequently to the light source 514A), a 7V line, and a 5V line (to be feed to the micro-controller 704). The subsea connector 720 may be a watertight connector head that plugs into the seafood catch monitoring device 100. The network hub 724 may combine multiple IP inputs into a single IP output.

It will be appreciated that the various operations, processes and methods disclosed herein may be embodied in a non-transitory machine-readable medium and/or a machine-accessible medium compatible with a data processing device (e.g. the seafood catch monitoring device 100, the data processing device 300). Accordingly, the specification and drawings are to be regarded in an illustrative rather than a restrictive sense.

A number of embodiments illustrating a device and/or systems for monitoring seafood gathering devices have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings are to be regarded in an illustrative rather than a restrictive sense.

What is claimed is:

1. A seafood catch monitoring device configured to enable monitoring of the subsea surroundings of the seafood catch monitoring device, comprising:
a cylindrical shell comprising:
a sensor generating data pertaining to the subsea surroundings of the seafood catch monitoring device;
a light source;
wherein the light source is one of a light-emitting device and a reflected beam of light,
wherein the sensor and the light source are rotatable around an axis extending to the ends of the cylindrical shell;
one or more electrical components coupled to the sensor, the light source, and additionally communicatively coupled to a data processing device,
wherein at least a part of the cylindrical shell is transparent.

2. The device of claim 1, further comprising:
a mounting bracket housed within the cylindrical shell and coupled to the sensor and a mirror,
wherein the mirror is angularly disposed to reflect a beam of light from the light source, and
wherein the mounting bracket is rotatable around the axis extending to the ends of the cylindrical shell or another axis extending to the ends of the cylindrical shell.

3. The device of claim 1, further comprising:
a mounting cradle assembly coupled to the seafood catch monitoring device comprising a mounting cradle,
wherein the mounting cradle is coupled to the seafood catch monitoring device,
wherein the seafood catch monitoring device is integrated into a trawl net by:
placing the trawl net between the seafood catch monitoring device and the mounting cradle; and
fastening the seafood catch monitoring device to the mounting cradle through one on more U-bolts.

4. The device of claim 3, further comprising:
an umbilical strain release coupled to the mounting cradle assembly and configured as a first point of failure and to prevent decoupling of the umbilical line from the one or more electrical components of the cylindrical shell.

5. The device of claim 1, further comprising:
wherein the seafood catch monitoring device comprises additional cylindrical shells coupled to the cylindrical shell, the additional cylindrical shells comprising one or more additional sensors and one or more additional light sources, and
wherein the one or more additional sensors and the one or more additional light sources are communicatively coupled to either of the one or more electrical components of the cylindrical shell or one or more electrical components of the additional cylindrical shells.

6. The device of claim 2, wherein the first cylindrical portion comprises:
a guide shaft coupled to both ends of the cylindrical shell;
a bearing block coupled to the guide shaft, the bearing block having a servo assembly to which a servo is coupled wherein the servo enables the mounting bracket to be rotated within the cylindrical shell;
a shaft collar coupled to the guide shaft, to which a bearing bracket is coupled, the bearing bracket housing one end of an idler shaft, and
wherein the mounting bracket is coupled to the servo assembly and the idler shaft.

7. The device of claim 1, wherein one of the one or more electrical components of the cylindrical shell is a controller card comprising:
a micro-controller; and
an encoder coupled to the sensor, the encoder receiving raw media data from the sensor through the micro-controller and transmitting the encoded media data to the data processing device via an internet protocol (IP).

8. A seafood catch monitoring system comprising:
a data processing device;
a seafood catch monitoring device configured to enable monitoring of the subsea surroundings of the seafood catch monitoring device, comprising:
a sensor generating data pertaining to the subsea surroundings of the seafood catch monitoring device;
a light source;
wherein the light source is one of a light-emitting device and a reflected beam of light,
wherein the sensor and the light source are rotatable around an axis extending to the ends of the cylindrical shell;
one or more electrical components coupled to the sensor, the light source, and additionally communicatively coupled to the data processing device,
wherein at least a part of the seafood catch monitoring device is transparent.

9. The system of claim 9, further comprising:
a mounting bracket of the cylindrical shell coupled to the sensor and a mirror,
wherein the mirror is angularly disposed to reflect a beam of light from the light source, and
wherein the mounting bracket is rotatable around the axis extending to the ends of the cylindrical shell or another axis extending to the ends of the cylindrical shell.

10. The system of claim 8, wherein the seafood catch monitoring device is coupled to a mounting cradle assembly comprising a mounting cradle,
wherein the mounting cradle is coupled to the seafood catch monitoring device,
wherein the seafood catch monitoring device is integrated into a trawl net by:
placing the trawl net between the seafood catch monitoring device and the mounting cradle; and
fastening the seafood catch monitoring device to the mounting cradle through one or more U-bolts.

11. The system of claim 10, further comprising an umbilical strain release coupled to the mounting cradle assembly and configured as a first point of failure and to prevent decoupling of the umbilical line from the electrical components of the cylindrical shell.

12. The system of claim 8, further comprising:
wherein the seafood catch monitoring system comprises one or more additional seafood catch monitoring devices, the one or more additional seafood catch monitoring devices comprising one or more additional sensors and one or more additional light sources, and
wherein the one or more additional sensors and the one or more additional light sources are communicatively coupled to either of the one or more electrical components of the seafood catch monitoring device or one or more electrical components of the one or more additional seafood catch monitoring devices.

13. The system of claim 8, wherein one of the one or more electrical components of the seafood catch monitoring device is a controller card comprising:
a micro-controller; and
an encoder coupled to the sensor, the encoder receiving raw media data from the sensor through the micro-controller and transmitting the encoded media data to the data processing device via an IP.

14. A seafood catch monitoring system comprising:
a seafood catch monitoring device comprising:
a sensor,
a light source,
a processor coupled to the sensor and the light, and
a memory storing instructions that when executed by the processor cause the seafood catch monitoring device to:
operate the sensor and the light source to enable monitoring of the subsea surroundings of the seafood catch monitoring system;
generate raw media through the sensor;
communicate the raw media to an encoder coupled to the processor;
encode, through the encoder, the raw media;
a data processing device comprising:
a decoder;
a display unit;
a processor communicatively coupled to the processor of the seafood catch monitoring device through a network and configured to receive encoded media from the seafood catch monitoring device through the network;
a memory storing instructions that when executed by the processor of the data processing device cause the data processing device to:
decode the encoded media through the decoder; and
display, through the processor, the decoded media on the display unit.

15. The system of claim 14, wherein the encoded media is stored in the memory of the data processing device.

16. The system of claim 14, wherein the encoded media is communicated to a remote server through the network.

17. The system of claim 14, wherein the sensor and the light source is configured to be rotatable through a control signal received by the data processing device.
